(19) United States
(12) Patent Application Publication
(10) Pub. No.: US 2009/0024504 A1
(43) Pub. Date: Jan. 22, 2009

(54) System and method for forecasting fluctuations in future data and particularly for forecasting security prices by news analysis

(76) Inventors: Kevin Lerman, Bellaire, TX (US); Ariel Gilder, Brooklyn, NY (US)

Correspondence Address: GOODWIN PROCTER LLP;ATTN: PATENT ADMINISTRATOR, 620 Eighth Avenue, NEW YORK, NY, 10018, US

(21) Appl. No.: 12/150,960

(22) Filed: May 2, 2008

Related U.S. Application Data
(60) Provisional application No. 60/927,250, filed on May 2, 2007.

(51) Int. Cl. G06Q 40/00

(52) U.S. Cl. 705/35

(57) ABSTRACT

A system and method for predicting price fluctuations in financial markets. Our approach utilizes both market history and public news articles, published before the beginning of trading each day, to produce a set of recommended investment actions. We empirically show that these markets are surprisingly predictable, even by purely market-historical techniques. Furthermore, analyzing relevant news articles captures information features independent of the markets history, and combining the two methods significantly improves results. Capturing usable features from news articles requires some linguistic sophistication the standard naïve bag-f-words approach does not yield predictive features. Instead, we use part-of-speech tagging, dependency parsing and semantic role labeling to generate features that improve system accuracy. We evaluate our system on eight political prediction markets from 2004 and show that we can make effective investment decisions based on our systems predictions, whose profits greatly exceed those generated by a baseline system.

### CROSS-REFERENCE TO RELATED APPLICATIONS

This application claims the benefit of our provisional application Ser. No. 60/927,250 filed on May 2, 2007, entitled “Forecasting Prediction Markets by News Content Analysis,” the entirety of which is incorporated herein by reference.

### FIELD OF THE INVENTION

The present invention relates to methods for predicting financial market performance. In particular, this invention relates to providing training models for predicting performance of predefined securities.

### BACKGROUND OF THE INVENTION

The mass media can affect world events by swaying public opinion, officials and decision makers. Financial investors who evaluate the economic performance of a company can be swayed by positive and negative perceptions about the company in the media, directly impacting its economic position. The same is true of politics, where a candidate's performance is impacted by media influence public perception, and many other related fields.

Computational linguistics can extract such information in the news. For example, Devitt and Ahmad (2007) gave a computable metric of polarity in financial news text consistent with human judgments. Koppel and Shtrimberg (2004) used a daily news analysis to predict financial market performance, though predictions could not be used for future investment decisions. Recently, a study conducted of the 2007 French presidential election showed a correlation between the frequency of a candidate's name in the news and electoral success (Veronis, 2007).

### BRIEF DESCRIPTION OF THE INVENTION

We present a computational system that uses both external linguistic information and internal market indicators to forecast public opinion as measured by prediction markets, or other financial markets. We use features from syntactic dependency parses of the news and a user-defined set of market entities. Successive news days are compared to determine the novel component of each day's news resulting in features for a machine learning system. A combination system uses this information as well as predictions from internal market forces to model prediction markets better than several baselines. Results on several political prediction markets from 2004 show that news articles can be mined to predict changes in public opinion.

Opinion forecasting differs from that of opinion analysis, such as extracting opinions, evaluating sentiment, and extracting predictions (Kim and Hovy, 2007). Contrary to these tasks, our system receives objective news, not subjective opinions, and learns what events will impact public opinion. For example, “oil prices rose” is a fact but will likely shape opinions. This work analyzes news (cause) to predict future opinions (effect). This affects the structure of our task: we consider a time-series setting since we must use past data to predict future opinions, rather than analyzing opinions in batch across the whole dataset.

Aspects, features and advantages of exemplary embodiments of the present invention will become better understood with regard to the following description in connection with the accompanying drawings. It should be apparent to those skilled in the art that the described embodiments of the present invention provided herein are illustrative only and not limiting, having been presented by way of example only. All features disclosed herein, including dimensions, materials, etc may be replaced by alternative features serving the same or similar purpose, unless expressly stated otherwise. Therefore, numerous other embodiments of the modifications thereof are contemplated as falling within the scope of the present invention as defined herein and equivalents thereto.

### BRIEF DESCRIPTION OF THE DRAWINGS

FIG. 1 is a flowchart overview of the system;

FIG. 2 shows results for different news features and combined system across five markets.

FIG. 3 shows two selections from the Kerry DNC market showing profits over time (days) for dependency news, history and combined systems.

FIG. 4 shows an example sentence, after having been linguistically preprocessed, and some of the feature labels extracted from it.

### DETAILED DESCRIPTION OF THE INVENTION

### Definitions

Security—Whatever is being traded, whose price movements we want to predict. This could be shares of some company's stock, or shares of a certain proposition in a prediction market.

Feature—A <label, number> pair that represents a piece of information about some day in a market. The data is contained in the number; the label simply indicates what the number represents (e.g. “Yesterday's price” or “Number of times the word ‘economy’ was mentioned today”)

Prediction Market—A market for securities whose value depends on the outcome of a particular proposition, e.g. “George Bush will win the 2004 US Presidential election”. See the “Prediction Markets” section for a full explanation. A prediction market is one kind of financial market

Our goal is to predict daily fluctuations in the price of securities. We do this by reading the day's news and examining some simple financial indicators. We train two machine learning models on all previously observed days: one using news data and one using financial indicators. We then use these models to generate two predictions for the current day's price movement, and then decide how to invest (buy or short-sell) according to a combination heuristic that considers each type of prediction's performance over the past few days.

Prior to using the system with a new security, a set of relevant entities must be defined. These are generally nouns related to the security (the candidate/company/product's name, those of major competitors). Aliases must be established so that different terms referring to the same entity (e.g. “Bush”, “Mr. President”) can be coidentified. This can be done either with a manually created list of equivalent terms, or by using automatic co-reference resolution: the former has the advantage of precision, while the latter has the advantage of recall (primarily from its treatment of pronouns). These lists are short—roughly 5 terms per market is all that's needed.

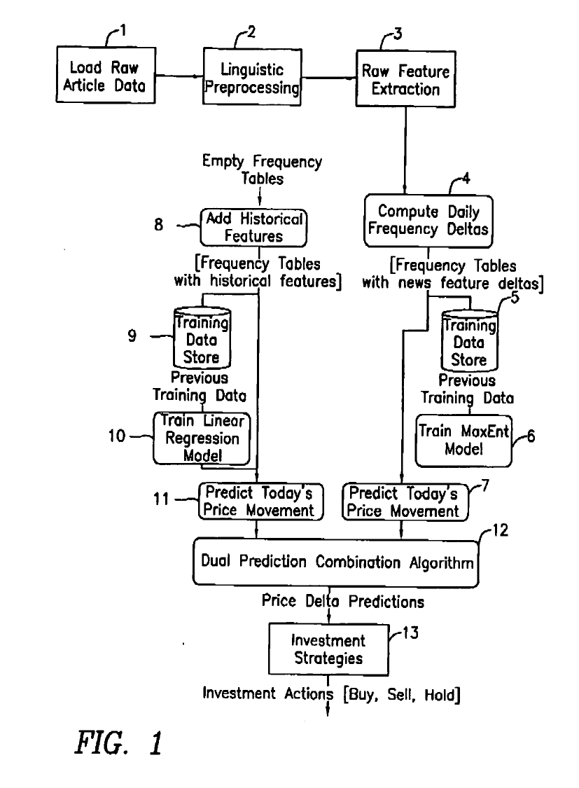

We present an overall system diagram in FIG. 1. Each numbered step is discussed in greater detail in the following sections.

Load Raw Article Data (1)

The current day's news must be gathered. This can be done with a standard crawler, or by using news aggregation services such as Google News or Factiva. Care must be taken to ensure that all news gathered is less than one day old, as the system attempts to find topic shifts between days. This is generally trivial, as news articles are marked with their date of publication.

Linguistic Preprocessing (2)

We employ several natural language analysis techniques in order to be able to learn relevant features from the news data. We scan each sentence of all observed news for a mention of one of the predefined entities (either by simple string matching or by use of an automatic named entity recognition system—several of these are also listed at the above URL), canonizing any we find to a standard representation of the entity they represent. If none is found, the sentence is discarded and not considered in any future steps. Otherwise, we preprocess that sentence by part-of-speech tagging it (identifying the words in the sentence as “noun”, “adjective”, “verb”, etc), and parsing it into a role-labeled dependency parse tree (Nivre and Scholz, 2004). These are standard NLP tasks with well-understood algorithms. See http://www-nlp.stanford.edu/links/statnlp.html for a list of several tools for each task.

Raw Feature Extraction (3)

Typically, representations of text in vector space for machine-learning purposes use a bag-of-words model, wherein each unique word is treated as a feature, and a document is represented as the set of mention counts for each word (e.g. “said” is mentioned 3 times, “meeting” is mentioned 15 times, etc). The counts are then typically normalized such that they sum to 1. However, as shown by Wiebe et al. (2005), it is important to know not only what is being said but about whom it is said. The term “victorious” by itself is meaningless when discussing an election—meaning comes from the subject. Similarly, the word “scandal” is bad for a candidate but good for the opponent. While oftentimes the subject being discussed may be inferred by simply looking for entities that occur in the same sentence as the word in question, there are many subtle cases in language where this approach may fail, particularly when more than one entity from the list constructed appears in the sentence:

Bush defeated Kerry in the debate.

Kerry defeated Bush in the debate.

Bush, the president of the USA, was defeated by Senator Kerry in last night's debate.

One might factor in proximity to help determine the subject, and possibly direction. However, a much more rigorous approach is to use the parse-tree information we determined earlier, and extract features directly from the parse trees. Here the feature labels will correspond to parse tree “fragments” (to be explained shortly), and each label's value will be the number of times we observe that label's fragment in the entire day's news (that is, across all parse trees observed for that day). After examining all available parse trees for the day, we prune any features whose value is below a certain threshold, and normalize the rest such that they sum to 1.

To find parse-tree fragments to make labels out of, we look at each parse tree generated from the day's news (one for each sentence that had a predefined entity in it), and iterate through the occurrences of the named entities that were identified back in step 2. Along the way, we keep track of the set of features we have extracted for this day so far. Because we are working with a dependency parse tree, each word of the sentence corresponds to a single node of the parse tree, and we can speak of a word's parent, sibling, child, etc. in the tree. For each of these, we generate a feature label indicating the word, part of speech, and semantic role label of:
The entity and its parent
The entity and its child (generate one label for every child it has)
The entity, its sibling, and their common parent (one label for each sibling it has)
The entity, its parent, and its grandparent
The entity, its grandparent, and its aunt (that is, grandparent's child that isn't the entity's parent. One of these for each aunt it has)
The entity, its parent, and its niece (that is, parent's grandchild that isn't the entity's child. One of these for each niece it has)

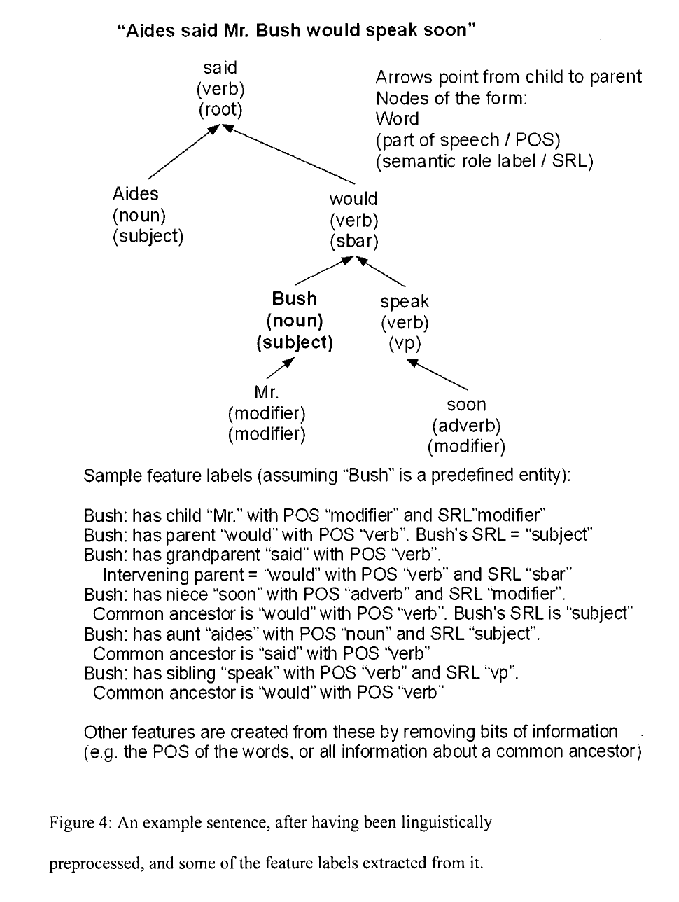

An example sentence that has been linguistically preprocessed is shown in FIG. 4, along with several example feature labels that would be extracted from it. For each label, we increment its value in the set of features observed so far today, indicating that we've seen another instance of the parse tree fragment it describes.

These feature labels are highly specific, and one might not reasonably expect to observe an instance of the associated parse tree fragment enough to be able to learn anything from it (in the “Machine Learning” phase). Therefore, we also generate “backoff” feature labels and increment these as well. These feature labels are generated by starting with one of our observed feature labels corresponding to a parse tree fragment, and removing some of the specificity of the label.

For example, while we might extract a feature label containing the words, parts of speech, and semantic role labels of the entity, its parent, and its grandparent, we would in addition extract another containing only the information about the entity and its grandparent—because this feature label in essence generalizes over the parent, it is something we might observe more frequently in the news. We also extract feature labels using all of the same words (e.g. entity, parent, grandparent), but leave out the value of the parent or grandparent's actual word, indicating only its part of speech and/or semantic role label. This feature label also is less specific: the parse-tree fragment it describes can contain any of hundreds or thousands of words in the parent or grandparent position, so long as their part of speech and/or semantic role label match.

Note that besides extracting more precise information from the news text, this handles sentences with multiple entities elegantly, since it associates parts of a sentence with different entities. Thus, our features are parse-tree relations instead of simple words, and as with the bag-of-words model, their values are mention counts. We found this approach dramatically more effective than a bag-of-words based feature representation. We record mention counts across all news observed on a given day, though one could break it down by tagging each feature with the news source it comes from (e.g. some text may mean one thing when the New York Times reports it, versus something else when a small local paper reports it). We then prune the feature vector, discarding any features for which the total number of observations is below a certain threshold.

At this point, we record the feature vector constructed, for use in the “Feature delta” processing step for future days.

TABLE 1
Implied examples of features from the general election market.
Arrows point from parent to child. Features also include the
word's dependency relation labels and parts of speech.

| | Good |
|---|---|
| Feature | For |
| Kerry ← plan → the | Kerry |
| poll → showed → Bush | Bush |
| won → Kerry | Kerry |
| agenda → 's → Bush | Kerry |
| Kerry ← spokesperson → | Bush |
| campaign | |

Feature Delta (4)

Public opinion is influenced by new events—a change in focus. If an oil company reports it has discovered a large, new source of oil, we would naturally expect demand for shares of that company's stock to increase, resulting in a price increase. However, while the find may be discussed for several days after the event, demand for the company's stock will probably not continue to rise on old news—that information has already been incorporated into the public's valuation of the company's stock. Changes in price should reflect changes in daily news coverage. Instead of having feature values reflect observations from the news for a single day, they can represent differences between two days of news coverage, i.e. the novelty of the coverage. Given the value of feature i on day t as fᵢ^{t}, the news focus change (Δ) for feature i on day t is defined as,

$$Δ {f}_{i}^{t} = log ( \frac{{f}_{i}^{t}}{\frac{1}{3} ( {f}_{i}^{t - 1} + {f}_{i}^{t - 2} + {f}_{i}^{t - 3} )} ) , \qquad ( 1 )$$

where the numerator represents the prevalence of feature i's parse-tree fragment today and the denominator is the average prevalence over the previous three days. The resulting value captures the change in focus on day t, where a value greater than 0 means increased focus and a value less than 0 decreased focus. In practice, we add a small constant to both the numerator and denominator, primarily to avoid division-by-zero errors.

At the end of the day, after we have made our decision, invested, and learned the actual price fluctuation, we will annotate this feature vector with its price movement and store it for use as training data for future iterations.

Machine Learning (6,7)

All previously observed days for this security are taken—each is a feature vector (that has already been processed as above), annotated with a price movement. All price movements, both in training and prediction, are converted into a simple binary up/down. We then train a maximum entropy model (Berger et al, 1996) on all previous days, trying to learn a function that classifies the days based on their features into two groups: the group consisting of days where the security's price rose, and the group consisting of days where the security's price fell. We bias the model to correctly classify days with large price movements accurately, at the expense of days with smaller price movements, by including a given day in the training set multiple times, in proportion to the magnitude of the day's price movement. This causes the learning algorithm to attach a higher importance to classifying the days with large price movements correctly, as the accuracy boost from doing so is greater than that for a day with a smaller price movement (that is, the model sees that it predicts another, say, five days correctly by correctly classifying a large-movement day, rather than just one for a small-movement day.). The resultant model is then applied to the new data—that representing the current day—and we observe which of the two groups the model classifies it into. This is our news-based prediction.

We use a similar technique in stages 10 and 11 of the flowchart as well: this is described in the next section.

Market-History Track (8-11)

The previous sections describe a prediction system based on related news.

However, news cannot explain all market trends. Momentum in the market, market inefficiencies, and slow news days can affect share price. A candidate who does well will likely continue to do well unless new events occur. Learning general market behavior can help explain these price movements.

For each day t, we create an instance using features for the price and volume at day t−1 and the price and volume change between days t−1 and t−2. We train using a ridge regression (which outperformed more sophisticated algorithms) on all previous days (labeled with their actual price movements) to forecast the movement for day t, which we convert into a binary value: up or down. This system works in parallel with the news system, generating two predictions for each day: one based on news, and another based on market history.

Combination Heuristic (12)

Since both news and internal market information are important for modeling market behavior, one cannot be used in isolation. For example, a successful news system may learn to spot important events for a candidate, but cannot explain the price movements of a slow news day. A combination of the market history system and news features is needed to model the markets.

Expert algorithms for combining prediction systems have been well studied. However, experiments with the popular weighted majority algorithm (Littlestone and Warmuth, 1989) yielded poor performance since it attempts to learn the optimal balance between systems while our setting has rapidly shifting quality between few experts with little data for learning. Instead, a simple heuristic was used to select the best performing predictor on each day. We compare the 3-day prediction accuracy (measured in total earnings) for each system (news and market history) to determine the current best system. The use of a small window allows rapid change in systems. When neither system has a better 3-day accuracy the combined system will only predict if the two systems agree and abstain otherwise. This strategy measures how accurately a news system can account for price movements when non-news movements are accounted for by market history. The combined system improved overall system performance dramatically above the results from using either system in isolation.

Investment Strategies (13)

Many investment strategies exist to maximize expected returns or to minimize risk given information about what the market is likely to do. We utilize a very simple investment strategy, chosen to facilitate evaluation rather than to maximize returns. Based on the prediction from the combination heuristic, we either buy or short-sell a single share of the security in question (or do neither if the heuristic has abstained from making a prediction). At the end of the day, we sell the share or cover the short-sale. In this way, all of our trades are short-term and impact our overall performance in proportion to the magnitude of the price shift over a single day. However, more sophisticated schemes can easily be specified in place of this one.

Evaluation

Prediction Markets

Prediction markets, such as TradeSports and the Iowa Electronic Markets (www.tradesports.com, www.biz.uiowa.edu/iem/), provide a setting similar to financial markets wherein shares represent not companies or commodities, but an outcome of a sporting, financial or political event. For example, during the 2004 US Presidential election, one could purchase a share of “George W. Bush to win the 2004 US Presidential election” or “John Kerry to win the 2004 US Presidential election.” A pay-out of $1 is awarded to winning shareholders once this can be determined, e.g. Bush wins (or loses) the election. In the interim, price fluctuations driven by supply and demand indicate the perception of the event's likelihood, which indicates public opinion of the likelihood of an event. Several studies show the accuracy of prediction markets in predicting future events (Wolfers and Zitzewitz, 2004; Servan-Schreiber et al., 2004; Pennock et al., 2000), such as the success of upcoming movies (Jank and Foutz, 2007), political stock markets (Forsythe et al., 1999) and sports betting markets (Williams, 1999).

Market investors rely on daily news reports to dictate investment actions. If something positive happens for Bush (e.g. Saddam Hussein is captured), Bush will appear more likely to win, so demand increases for “Bush to win” shares, and the price rises. Likewise, if something negative for Bush occurs (e.g. casualties in Iraq increase), people will think he is less likely to win, sell their shares, and the price drops.

Daily pricing information was obtained from the Iowa Electronic Markets for the 2004 US Presidential election for three Democratic primary contenders (Clark, Dean, and Kerry) and two general election candidates (Bush and Kerry). Market length varied as some candidates entered the race later than others: the DNC market for Kerry was 332 days long, while Dean's was 130 days and Clark's 106. The general election market for Bush was 153 days long, while Kerry's was 142—the first 11 days of the Kerry general election market were removed due to strange price fluctuations in the data. The price delta for each day was taken as the difference between the average price between the previous and current day. Market data also included the daily volume that was used as a market history feature. Entities selected for each market were the names of all candidates involved in the election and “Iraq.”

Experiment Setup

Our news corpus contained approximately 50 articles per day over a span of 3 months to almost a year, depending on the market. While 50 articles may not seem like much, humans read far less text before making investment decisions.

While most classification systems are evaluated by measuring their accuracy on cross-validation experiments, both the method and the metric are unsuitable to our task. A decision for a given day must be made with knowledge of only the previous days, ruling out cross-validation. In fact, we observed improved results when the system was allowed access to future articles through cross-validation. Further, raw prediction accuracy is not a suitable metric for evaluation because it ignores the magnitude in price shifts each day. A system should be rewarded in proportion to the significance of the day's market change.

To address these issues we used a chronological evaluation where systems were rewarded for correct predictions in proportion to the magnitude of that day's shift, i.e. the ability to profit from the market. Essentially, we ran an investing simulation. On each day, the system is provided with all available morning news and market history, from which two instances are created (one for news, one for market history). We then predict, using the news and market history systems as well as the combination heuristic, whether the market price will rise or fall and invest accordingly, either buying or short-selling a single share. At the end of the day we “undo” the trade, selling the share we bought or covering the short sale. The net effect of this trading scheme is that the system either earns or loses an amount of money equal to the price change for that day if it was right or wrong respectively. The system then learns the correct price movement and the process is repeated for the next day. Scores were normalized for comparison across markets using the maximum profit obtainable by an omniscient system that always predicts correctly—that is, the maximum amount of money possible to be earned under the given investment strategy of only buying/selling one share per day.

Baseline systems for both news and market history are included. The news baseline follows the spirit of a study of the French presidential election (Veronis, 2007), which showed that candidate mentions correlate to electoral success. Attempts to follow this method directly—predicting price movement based on raw candidate mentions—did very poorly. Instead, we trained our learning system with features representing daily mention counts of each entity. For a market history baseline, we make a simple assumption about market behavior: the current market trend will continue, predict today's behavior for tomorrow.

Results

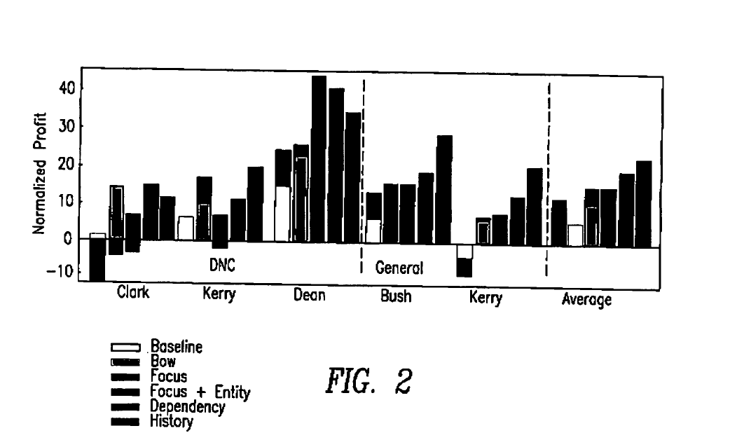

Results for news based prediction systems are shown in FIG. 2. The figure shows the profit made from both news features (bottom bars) and market history (top black bars) when evaluated as a combined system. Bottom bars can be compared to evaluate news systems and each is combined with its top bar to indicate total performance. Negative bars indicate negative earnings (i.e. weighted accuracy below 50%). Averages across all markets for the news systems and the market history system are shown on the right. In each market, the baseline news system makes a small profit, but the overall performance of the combined system is worse than the market history system alone, showing that the news baseline is ineffective. However, all news features improve over the market history system; news information helps to explain market behaviors. Additionally, each more advanced set of news features improves, with dependency features yielding the best system in a majority of markets. The dependency system was able to learn more complex interactions between words in news articles. As an example, the system learns that when Kerry is the subject of “accused” his price increases but decreased when he is the object. Similarly, when “Bush” is the subject of “plans” (i.e. Bush is making plans), his price increased. But when he appears as a modifier of the plural noun “plans” (comments about Bush policies), his price falls. Earning profit indicates that our systems were able to correctly forecast changes in public opinion from objective news text.

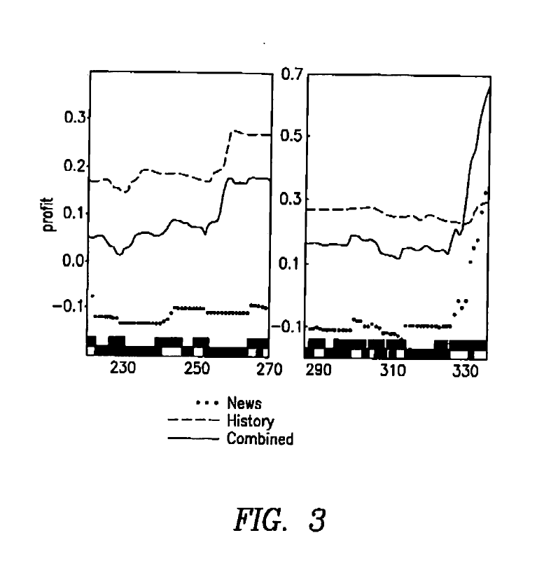

The combined system proved an effective way of modeling the market with both information sources. FIG. 3 shows the profits of the dependency news system, the market history system, and the combined system's profits and decision on two segments from the Kerry DNC market. In the first segment, the history system predicts a downward trend in the market (increasing profit) and the second segment shows the final days of the market, where Kerry was winning primaries and the news system correctly predicted a market increase.

Veronis (2007) observed a connection between electoral success and candidate mentions in news media. The average daily mentions in the general election was 520 for Bush (election winner) and 485 for Kerry. However, for the three major DNC candidates, Dean had 183, Clark 56 and Kerry (election winner) had the least at 43. Most Kerry articles occurred towards the end of the race when it was clear he would win, while early articles focused on the early leader Dean. Also, news activity did not indicate market movement direction; median candidate mentions for a positive market day was 210 and 192 for a negative day.

Dependency news system accuracy was correlated with news activity. On days when the news component was correct—although not always chosen—there were 226 median candidate mentions compared to 156 for incorrect days. Additionally, the system was more successful at predicting negative days. While days for which it was incorrect the market moved up or down equally, when it was correct and selected it predicted buy 42% of the time and sell 58%, indicating that the system better tracked negative news impacts.

Related Work

Many studies have examined the effects of news on financial markets. Koppel and Shtrimberg (2004) found a low correlation between news and the stock market, likely because of the extreme efficiency of the stock market (Gidófalvi, 2001). Two studies reported success but worked with a very small time granularity (10 minutes) (Lavrenko et al., 2000; Mittermayer and Knolmayer, 2006). It appears that neither system accounts for the time-series nature of news during learning, instead using cross-validation experiments which is unsuitable for evaluation of time-series data. Our own preliminary cross-validation experiments yielded much better results than chronological evaluation since the system trains using future information, and with much more training data than is actually available for most days. Recent work has examined prediction market behavior and underlying principles (Serrano-Padial, 2007). For a sample of the literature on prediction markets, see the proceedings of the recent Prediction Market workshops (http://betforgood.com/events/pm2007/index.html). Pennock et al. (2000) found that prediction markets are somewhat efficient and some have theorized that news could predict these markets, which we have confirmed (Debnath et al., 2003; Pennock et al., 2001; Servan-Schreiber et al., 2004).

Others have explored the concurrent modeling of text corpora and time series, such as using stock market data and language modeling to identify influential news stories (Lavrenko et al., 2000). Hurst and Nigam (2004) combined syntactic and semantic information for text polarity extraction.

Our task is related to but distinct from sentiment analysis, which focuses on judgments in opinions and, recently, predictions given by opinions. Specifically, Kim and Hovy (2007) identify which political candidate is predicted to win by an opinion posted on a message board and aggregate opinions to correctly predict an election result. While the domain and some techniques are similar to our own, we deal with fundamentally different problems. We do not consider opinions but instead analyze objective news to learn events that will impact opinions. Opinions express subjective statements about elections whereas news reports events. We use public opinion as a measure of an events impact. Additionally, they use generalized features similar to our own identification of entities by replacing (a larger set of) known entities with generalized terms. In contrast, we use syntactic structures to create generalized n-gram features. Note that our features (table 1) do not indicate opinions in contrast to the Kim and Hovy features. Finally, Kim and Hovy had a batch setting to predict election winners while we have a time-series setting that tracked daily public opinion of candidates.

### CONCLUSION

In conclusion, we have presented a system capable of predicting fluctuations in security prices well enough to trade profitably. We utilize a small, one-time bit of hand-crafted information (the set of relevant entities), the raw text of naturally-occurring news, and a very simple analysis of financial indicators. All parts of the system are modular, in that more sophisticated financial analyses, combination algorithms, investment schemes, or news analysis techniques may be substituted easily to create increasingly sophisticated systems. The two subsystems (news and technical analysis) perform well under different conditions, reflecting the fact that they are capturing different, non-redundant information, underscoring the importance of using the two jointly.

Although illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention

What is claimed is:

1. A method of predicting the future performance of one or more predefined securities, the method including:
receiving raw data representing language including sentences relating to one or more predefined securities whose future performance is to be predicted;
scanning the raw data for references to one or more of the predefined securities and providing the reference as a standard representation thereof;
preprocessing the sentences containing references to at least one of said one or more predefined securities to provide a relationship structure of one or more words in the preprocessed sentences; and
providing a training model for one or more of the relationship structures to predict future performance of one or more of the predefined securities.

2. The method of claim 1 in which the future performance being predicted is price movement.

3. The method of claim 1 in which said training model uses multiple copies of relationship structures for certain past trading days in proportion to price movements on said certain days.

4. The method of claim 1 also including:
receiving data representing price movement of certain past trading days; and
using said data representing price movement of certain past trading days to modify said prediction of future performance of one or more of said predefined securities
